(19) United States
(12) Patent Application Publication
(10) Pub. No.: US 2006/0002373 A1
(43) Pub. Date: Jan. 5, 2006

(54) Terminals, methods, systems, and computer program products for providing video communications over a broadband connection based on a call via a PSTN

(76) Inventor: Michael Denny, Sharpsburg, GA (US)

Correspondence Address: Robert N. Crouse;Myers Bigel Sibley & Sajovec, P.A., P.O. Box 37428, Raleigh, NC, 27627, US

(21) Appl. No.: 10/881,852

(22) Filed: Jun. 30, 2004

(51) Int. Cl. H04L 12/66

(52) U.S. Cl. 370/352

(57) ABSTRACT

A video capable communications terminal can include a public switched telephone network (PSTN) interface circuit that can be configured to interface the video capable communications terminal to a PSTN for a call therefrom to a destination. An out-of-band circuit can be configured to provide information related to video capability of a device included in the call via the PSTN. A broadband network interface circuit can be configured to interface the video capable communications terminal to a broadband network for video communications with the device over the broadband network. Related methods are disclosed.

### FIELD OF THE INVENTION

The invention relates to communications in general, and more particularly, video communications over broadband networks.

### BACKGROUND

Video conferencing can be provided by communications terminals sometimes referred to as videophones. Typically, videophones have been designed to be compatible with a particular type of transport. For example, it is known to provide videophones that are dedicated for use over Integrated Services Digital Network (ISDN). As such, any party wishing to participate in a video conference needed access to the same type of transport (i.e., ISDN) used by the other participants.

These types of limitations have been addressed by providing videophones that support multiple types of transports. For example, one type of videophone marketed by Motion Media (motion.-media.com), supports telephony via a Public Switched Telephone Network (PSTN) as well as Internet Protocol (IP) telephony. Also, published U.S. patent application Ser. No. 20030214573, discusses a videophone that supports Internet and PSTN in a single unit to provide a video communications capability over these types of transports. Notwithstanding the advancements made in the area of videophones, there is an outstanding need for further improvement in this area.

### SUMMARY

Embodiments according to the invention can provide terminals, methods, systems, and computer program products for providing video communications over a broadband connection based on a call via a PSTN. Pursuant to these embodiments, a video capable communications terminal can include a public switched telephone network (PSTN) interface circuit that can be configured to interface the video capable communications terminal to a PSTN for a call from a source to a destination. An out-of-band circuit can be configured to provide information related to video capability of a device included in the call via the PSTN. A broadband network interface circuit can be configured to interface the video capable communications terminal to a broadband network for video communications with the device over the broadband network.

In some embodiments according to the invention, the out-of-band circuit is further configured to provide the information to a device associated with the source. In some embodiments according to the invention, the out-of-band circuit is further configured to provide the information to a device associated with the destination.

In some embodiments according to the invention, the out-of-band circuit is further configured to provide the information related to video capability via a communications channel outside a PSTN audio channel used by the PSTN to provide audio information during the call. In some embodiments according to the invention, the communications channel can be provided via an Advanced Intelligent Network (AIN). In some embodiments according to the invention, the communications channel can be provided via a network that is separate from the PSTN.

In some embodiments according to the invention, the PSTN interface circuit can be further configured to provide audio information to/from the video capable communications terminal associated with the video communications over the broadband network. In some embodiments according to the invention, the broadband network interface circuit can be further configured to provide audio information to/from the video capable communications terminal associated with the video communications over the broadband network.

In some embodiments according to the invention, the video capable communications terminal can further include a processor circuit that can be configured to enable the broadband network interface circuit to provide video communications over the broadband network based on the information related to video capability associated with the destination. In some embodiments according to the invention, the processor circuit can be further configured to enable the broadband network interface circuit based on an input to use the video capability associated with the destination.

In some embodiments according to the invention, the video capable communications terminal can further include a keypad that can be configured to provide input to the processor circuit based on a user selection to use the video capability associated with the destination. In some embodiments according to the invention, the video capable communications terminal can include a wireless video capable communications terminal.

In some embodiments according to the invention, the broadband network interface circuit can be a DSL network interface circuit, a cable network interface circuit, an ISDN interface circuit, and/or a wideband wireless interface circuit. In some embodiments according to the invention, the broadband network interface circuit can be further configured to receive address information for the device having the video capability associated with the destination. In some embodiments according to the invention, the address information can be an Internet Protocol address for the device associated with the destination.

In some embodiments according to the invention, methods of providing for video communications between communications terminals can include: routing a call from a source to a destination via a public switched telephone network (PSTN), wherein the source and destination are each associated with respective video capable communications terminals, receiving a request for video communications between the source and a destination via an out-of-band communications channel outside a PSTN audio channel used by the PSTN to provide audio information during the call, providing information to the source and the destination for establishment of a broadband network connection between respective video capable communications terminals for video communications therebetween, and establishing the broadband connection between the respective video capable communications terminals based on respective address information associated therewith.

In some embodiments according to the invention, methods of providing for video communications between communications terminals can include: receiving a request for video communications between a source and a destination based on a call via a public switched telephone network (PSTN) and providing information to the source and the destination for establishment of a broadband network connection between devices associated with the source and destination for video communications therebetween.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram that illustrates video communications terminals according to some embodiments of the invention.

FIG. 2 is a schematic illustration of a video capable communications terminal (terminal) according to some embodiments of the invention connected to a PSTN and a broadband network.

FIG. 3 is a schematic illustration of video capable communications terminal connected via a broadband connection according to some embodiments of the invention.

FIG. 4 is a flowchart that illustrates the operation of video capable communications terminals according to some embodiments of the invention.

### DETAILED DESCRIPTION OF EMBODIMENTS ACCORDING TO THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “coupled to” another element, it can be directly coupled to the other element or intervening elements. In contrast, when an element is referred to as being “directly coupled to” another element, there are no intervening elements present. Like numbers refer to like elements throughout. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element, component, region, layer or section from another region, layer or section. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention may be embodied as terminals, methods, and/or systems. Accordingly, the invention may be embodied in hardware and/or in software (including firmware, resident software, micro-code, etc.). The invention may also be embodied as a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Some embodiments according to the invention are described herein in the context of a broadband network and a broadband network connection. As used herein, the term “broadband network” can include any network that can provide bandwidth to video capable communications terminals according to the invention to enable adequate video communications therebetween. For example, video communications may be enabled by providing enough network bandwidth for about one video frame per second to be transmitted/received by the participating video capable terminals. In general, the invention is not limited to any communication technology and/or network configuration, but is intended to encompass any technology and/or network configuration capable of carrying out operations described herein. For example, in some embodiments according to the invention, the “broadband network” may be provided by digital subscriber line (DSL), asynchronous transfer mode (ATM), frame relay, hybrid fiber coax (HFC), wireless broadband, Ethernet, cable network over, for example, the Internet and/or a private network.

Embodiments of the invention are disclosed herein with reference to video capable communications terminals, such as videophones. However, it will be understood that the invention can be practiced with any type of electronic device that has video capability for purposes of providing video communications over a broadband network. For example, the invention can be practiced with, among other things, a landline videophone; a cellular radiotelephone; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, etc.; and a laptop and/or palmtop computer or other appliance which includes a telephone transceiver any of which include the video capabilities described herein. It will be understood that the term “video capable” or “video capability” can include audio capability and/or information as well as strictly video capability and/or information.

Embodiments according to the invention can provide video capable communications terminals that include a public switched telephone network (PSTN) interface circuit that is configured to interface the video capable communications terminal to a PSTN for a call therefrom to a destination. An out-of-band circuit also included in the video capable communications terminal is configured to provide information related to the video capability of a device that is associated with the call via the PSTN. The video capable communications terminal also can include a broadband network interface circuit that is configured to interface the terminal to a broadband network for video communication with the device over the broadband network.

In some embodiments according to the invention, the out-of-band circuit is configured to provide video information that is related to the video capability of a device associated with the source (to the destination) of the call made by the PSTN. In some embodiments according to the invention, the out-of-band circuit is configured to provide information (to the source of the call) that is related to the video capability of a device associated with the destination of the call.

Therefore, video capable communications terminals according to some embodiments of the invention can be used to exchange information related to the video capability of the device associated with the source/destination of the call made by the PSTN. For example, in some embodiments according to the invention, a call made from a source video capable communications terminal to a destination video capable communications terminal can exchange information related to the video capability of respective devices associated with the source and destination. Furthermore, the devices associated with the source and destination need not be the devices that originate and/or receive the call via the PSTN. For example, the devices can be separate camera and displays that are associated with, for example, the source of the call. Also, in some embodiments according to the invention, the device associated with the source (or destination) can be different than the device associated with the destination (or source). Moreover, the source (or destination) may have multiple devices associated therewith whereas the destination (or source) may have a single device associated therewith.

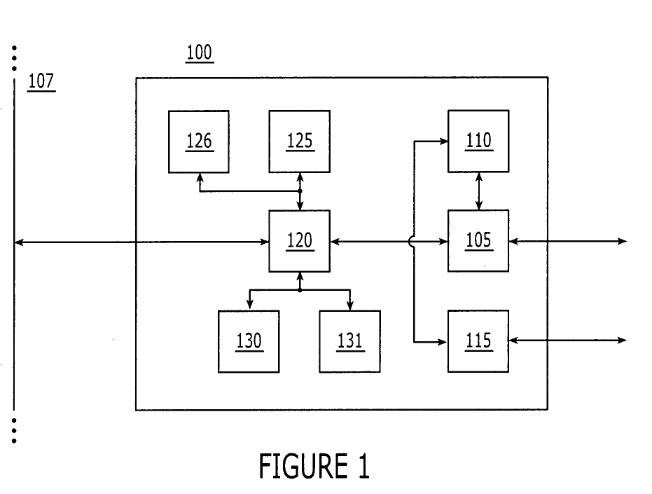

FIG. 1 is a block diagram that illustrates video capable communications terminals according to some embodiments of the invention. In particular, a terminal 100 according to embodiments of the invention can include a user interface having a variety of components, such as a display 125 capable of displaying video images as part of a video conference, a speaker 130, a microphone 131, and a keypad 126, operations of which are known to those skilled in the art. It will be understood that the display 125 can be used to provide video that is associated with a call between the terminal 100 and another terminal to which a call is placed. Furthermore, audio associated with the video can be provided by the speaker 130 and microphone 131.

A Public Switched Telephone Network (PSTN) interface circuit 105 is configured to interface the terminal 100 to a PSTN (not shown). It will be understood that in operation, the terminal 100 can initiate and receive calls made via the PSTN to/from the terminal 100. For example, the terminal 100 may be the source of a call made via the PSTN (over the PSTN interface circuit 105) to a destination which may be another terminal 100. Also, the terminal 100 can receive calls via the PSTN and thereby act as the destination called by another terminal 100 (which acts as the source of the call).

The terminal 100 also includes a broadband network interface circuit 115 that is configured to interface the terminal 100 to a broadband network (not shown) for video communications over the broadband network. It will be understood that the broadband network interface circuit can be configured to interface to any type of network that can provide adequate bandwidth for the transmission of video information for the purposes of conducting a videoconference. In some embodiments according to the invention, the broadband network interface circuit 115 can be configured to interface to a DSL network, a cable network, an integrated services digital network, a wireless network (such as a wideband CDMA 2000) which may be coupled to the Internet or a private network over which video communications may flow to/from other terminals 100.

The terminal 100 also includes an out-of-band circuit 110 that is configured to provide information related to the video capability of a device that is included in the call that is made via the PSTN and a processor circuit 120 that is configured to coordinate overall operations of the elements of the terminal 100. For example, in some embodiments according to the invention, the out-of-band circuit 110 is configured to provide information related to the video capability of the terminal 100 (such as the fact that the terminal 100 includes the video display 125, the speaker 130, and the microphone 131). In some embodiments according to the invention, the out-of-band circuit is configured to provide information related to the video capability of a device that is associated with the destination called via the PSTN. For example, the out-of-band circuit 110 may provide information related to the video capability of another terminal 100 that is the destination called via the PSTN. In particular, the video information provided by the out-of-band circuit 110 from the destination terminal 100 can indicate whether the destination terminal 100 includes a video display, a speaker, and a microphone.

It will be understood that the out-of-band circuit 110 can be configured to interact with what is commonly referred to as out-of-band signaling, such as signaling used between central offices to provide information that can be typically sent to the terminal 100 by one of the offices with the audio. Accordingly, the out-of-band circuit 110 has the capability to extract the embedded out-of-band signaling information transmitted from the central office. Such out-of-band signaling is commonly provided by the SS7 signaling network known to those skilled in the art.

In some embodiments according to the invention, the video information provided by the out-of-band circuit 100 can include address information that can be used to establish a connection between the devices associated with the source and destinations via the broadband network interface circuit 115 over the broadband network. In some embodiments according to the invention, the communications channel used by the out-of-band circuit 110 is provided by a network that is separate from the PSTN, such as a local wireless network, for example, an IEEE 802.11(g) compliant network.

It will be further understood that the out-of-band circuit 110 may be included (wholly or in-part) in the other components shown in FIG. 1. For example, the functionality of the out-of-band circuit 110 may be included in a separate circuit that interfaces to the PSTN interface circuit 105. In some embodiments according to the invention, the out-of-band circuit 110 may interface to the PSTN directly or interfaces via the PSTN interface circuit 105.

It will be further understood that the terminal 100 can include a network interface (not shown) that allows the terminal 100 to interact with other devices that may have capabilities that may be used during a video conference. Accordingly, the terminal 100 shown in FIG. 1 may represent a source that is coupled to other devices associated therewith over a local network 107. For example, the display 125, speaker 130, and microphone 131 may all be associated with the source that is identified by a telephone number associated with the terminal 100. It will further be understood that the devices located on the local network coupled to the terminal 100 may also be associated with the source and may be separately controlled using address information for each of the associated devices having different video capabilities. For example, one of the devices associated with the source may be a large format display that has a separate Internet protocol (IP) address associated therewith such that the large format display may receive the same video received by the display 125 (referred to herein as a “multicast”).

In some embodiments according to the invention, the out-of-band circuit 110 is configured to provide the information related to the video capability using a communications channel that is outside a PSTN audio channel that is used during the call. For example, the communications channel can be provided via an Advanced Intelligent Network (AIN), such as the Telecordia/Bellcore version of an “intelligent network” which is commonly referred to as the public switched telephone network. As is known to those skilled in the art, the AIN (between central offices) provides enhanced voice, video/data services, and dynamic writing capabilities by using two different networks. In particular, audio information associated with a call over the PSTN is transmitted via a circuit-switched network, whereas the signaling is done on a separate packet-switched network known as signaling system seven (SS7).

The AIN may be thought of as interoffice signaling that uses Advanced Intelligent Network messages known as triggers to be generated and to provide the appropriate responses. A trigger is a particular event that generates a new AIN message sequence. Customers of the local exchange carriers can pay a tariff for having triggers provided to the AIN in connection with particular trigger events. For example, specialized services that relate to inbound calls to a number normally require the customer for that directory number to subscribe to a termination attempt trigger. This generates an AIN message whenever the network detects that some party has attempted to place a call to that particular directory number. Service control points can then access their respective databases to determine what non-standard response may be appropriate for the handling of the call given that a trigger was received.

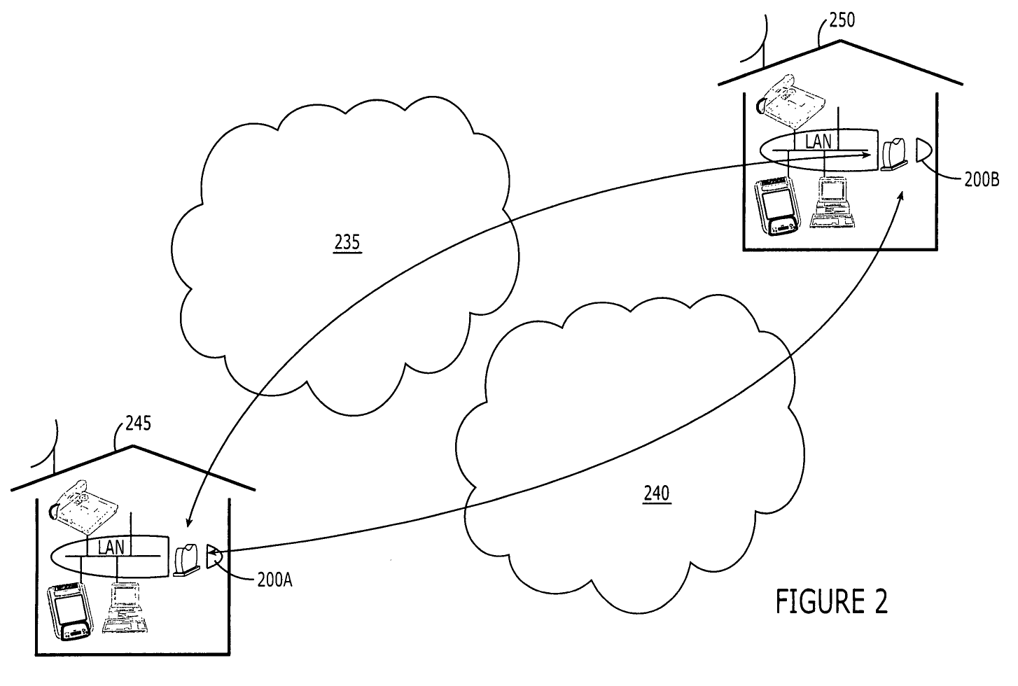

FIG. 2 is a schematic diagram that illustrates operations of terminals according to some embodiments of the invention. In particular, a terminal 200A according to embodiments of the invention is located at a source 245 of a call. The terminal 200A is coupled to a local area network (LAN) having devices thereon which have video capabilities that may be used during video communications with other terminals according to embodiments of the invention. The terminal 200A is coupled to a PSTN 235 over which calls may be placed to destinations. The terminal 200A is also coupled to a broadband network 240 over which video communications may occur between the terminal 200A associated with the source 245 and a remote destination. It will be understood that the terminals 200A and 200B can each include audio capabilities. In particular, the terminals 200A and 200B can each support video communications therebetween as well as audio information therebetween and comprise what is commonly referred to as a videophone.

A destination 250 includes a terminal 200B that is coupled to a respective local area network having devices coupled thereto that may be associated with the destination 250. The terminal 200B is also coupled to the PSTN 235 and to the broadband network 240. It will be understood that the terminals 220A and 200B can be a terminal according to some embodiments of the invention described, for example, in reference to FIG. 1, having video capabilities.

In operation, a call can be placed from the source 245 to the destination 250 via the PSTN 235. The call can connect the terminal 200A that is associated with the source 245 with the terminal 200B associated with the destination 250. For example, the call from the source 245 to the destination 250 may be accomplished by placing a phone call to a telephone number that identifies the destination 250. Upon establishment of a call between the source 245 and the destination 250, the terminals 200A and 200B each provide information related to respective video capabilities to one another. In particular, the terminal 200A provides information related to its video capability to the terminal 200B, whereas the terminal 200B provides respective information related to its video capability to the terminal 200A.

It will be understood that the video capabilities of the terminals 200A and 200B can be provided using the out-of-band circuit 110 described above. In some embodiments according to the invention, the information related to video capabilities in the devices can be provided via an AIN or another network that is separate from the channel used by the PSTN for audio information during the call.

The information related to the video capability of the devices can include addressability information indicating how many pixels are accommodated by the display (e.g., 1024×768), maximum sustainable frame rate, audio characteristics (such as mono/stereo), compression/decompression hardware capabilities, network address information, which standards are supported by the device, such as H.323, and the like. In some embodiments according to the invention where the broadband connection is established via the Internet, the terminals 200A and 200B each provide an IP address that can be used to establish the broadband connection with each other over the broadband network 240. In some embodiments according to the invention, the broadband network 240 is provided by a DSL or cable connection to the Internet or a private network that can be used to couple the terminal 200A to the terminal 200B.

Upon establishment of the call between the terminals 200A and 200B, each of the users of the terminals 200A and 200B may be queried as to whether the video capability of the terminals 200A and 200B associated with the source 245 and destination 250, respectively, should be utilized during the call. Further, if the users elect to utilize the video capabilities of each of the terminals 200A and 200B, the processor circuit 120, described in reference to FIG. 1, is configured to enable the broadband network interface circuit 115 so that the broadband connection between the terminal 200A and the terminal 200B can be established.

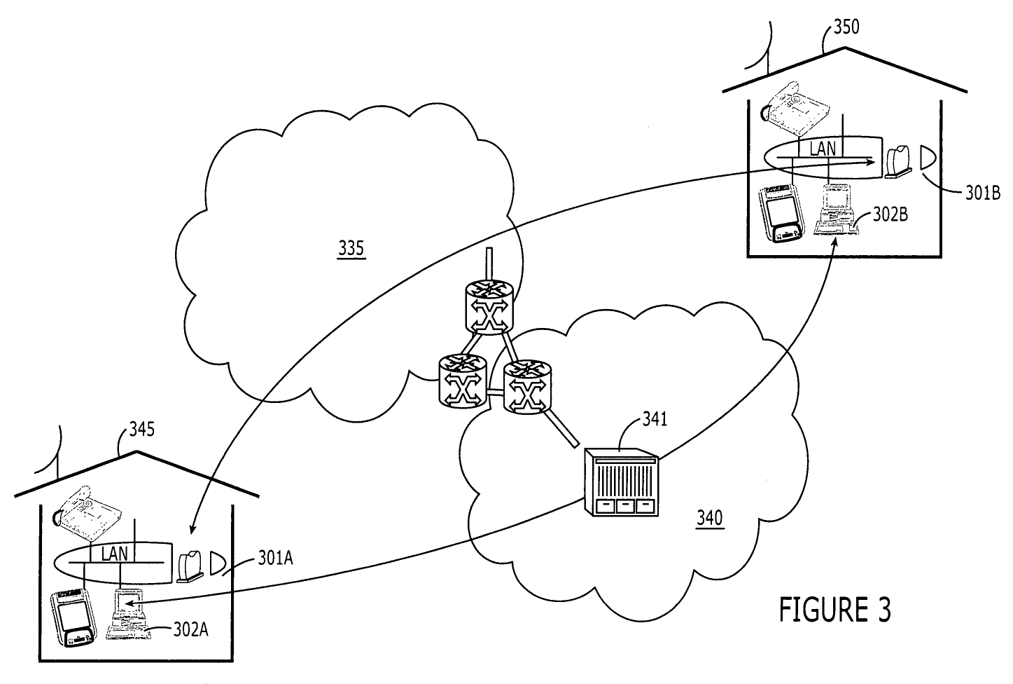

FIG. 3 is a schematic diagram that illustrates operation of video capable communications terminals according to some embodiments of the invention. According to FIG. 3, a call can be placed from a source 345 to a destination 350 via a PSTN 335. For example, the call can be placed over a PSTN 335 from the source 345 by dialing the telephone number of the destination 350. The source and destination can have multiple devices having video capabilities associated therewith. For example, the source 345 can have a number of devices associated therewith (via for example, a local area network) each of which can have different video capabilities. Similarly, the destination 350 can have a number of devices associated therewith (via for example, a local area network) each of which can have different video capabilities.

Upon establishment of the call between the terminal 301A and the terminal 301B, each of the respective terminals, 301A, 301B provides information related to the video capability of devices associated with the source 345 and the destination 350. In particular, the terminal 301A can provide information related to the video capability of another device associated with the source 345, such as a computer having videophone hardware and software thereon that is coupled to the terminal 301 via a local area network at the source 345. Furthermore, the terminal 301A can also provide information related to the video capability of other devices associated with the destination 350 to the computer 302A.

The terminal 301B provides the information related to the video capability of a local computer 302B having video hardware and software thereon coupled to the terminal 301B via a local area network. Furthermore, the terminal 301B provides the information related to the video capability of the computer 302A associated with the source 345 to the computer 302B. In some embodiments according to the invention, the information related to the video capability of the respective devices associated with the source 345 and the destination 350 can include address information that can be used to establish a broadband connection between the computer 302A and the computer 302B over a broadband network 340.

In some embodiments according to the invention, the broadband connection is established between the computer 302A and the computer 302B by an application server 341 that is coupled to the broadband network 340. In some embodiments according to the invention, the information related to the video capability of the computer 302A and the computer 302B is provided to the application server 341 via an out-of-band circuit that couples the PSTN 335 to the broadband network 340. The application server can represent a video communication service that establishes the broadband connection between subscribers associated with the computer 302A and the computer 302B.

In particular, the application server 341 can receive a request for video communication between the source 345 and the destination 350 based on the call established therebetween. In response, the application server 341 can provide information to the source 345 and destination 350 for establishment of the broadband connection between devices that are associated with the source 345 and destination 350 for video communications therebetween. For example, in some embodiments according to the invention, the application server 341 receives a request for video communications between the source 345 and destination 350 via an AIN that is coupled to the broadband network 340. Accordingly, the application server 341 provides the information to the source 345 and destination 350 for the establishment of the broadband network connection between the computer 302A and the computer 302B.

It will be understood that in some embodiments according to the invention, the request for video communications between the source and destination can include information related to the video capability of the devices associated with that source and destination for which the broadband connection is to be established. For example, the information provided by the AIN can include an IP address for the computer 302A and an IP address for the computer 302B. Furthermore, the information provided by the AIN can also include address information for multiple devices such as when one device associated with the source 345 has video capability whereas a second device associated with the source 345 has audio capabilities associated therewith.

In some embodiments according to the invention, the audio and video information may be provided in separate streams over the broadband network 340. In some embodiments according to the invention, the audio information may be provided via the PSTN 335 separate from the video information provided by the broadband network 340. For example, the audio information may be provided by the PSTN 335 as an ongoing portion of a call established between the terminals 301A and 301B, whereas the video communication is provided via the broadband network 340 to devices that are separate from the terminals 301A and 301B. For example, in some embodiments according to the invention, the audio information may be provided to the terminals 301A and 301B whereas the video information is provided to the computers 302A, 302B.

In still other embodiments according to the invention, only one of the source 345 and destination 350 is equipped with a video capable communications terminal according to embodiments of the invention, whereas the other location is equipped, for example, with a PSTN telephone as described above. Accordingly, in operation, the audio and video communications may be provided to a single device at one location and provided to separate devices at the other location. Furthermore, in some embodiments according to the invention, the same video information may be provided to more than one device at the source 345 or destination 350. For example, the video information may be provided to multiple display devices as a part of a multicast at either the source or the destination. In some embodiments according to the invention, therefore, the application server 341 or resources associated with the source or destination can maintain a database that associates devices for video communications at that location. For example, in some embodiments according to the invention, the application server 341 may store IP addresses for each of the devices associated with the source 345 and the destination 350 that has video capability. Furthermore, selective ones of the devices may be associated with one another. For example, certain displays located at the source 345 may be grouped together for purposes of multicast whereas other devices at the source 345 may be addressed separately. It will further be understood that although only two locations are shown in the figures herein, more than two locations may be interfaced to one another according to embodiments of the invention.

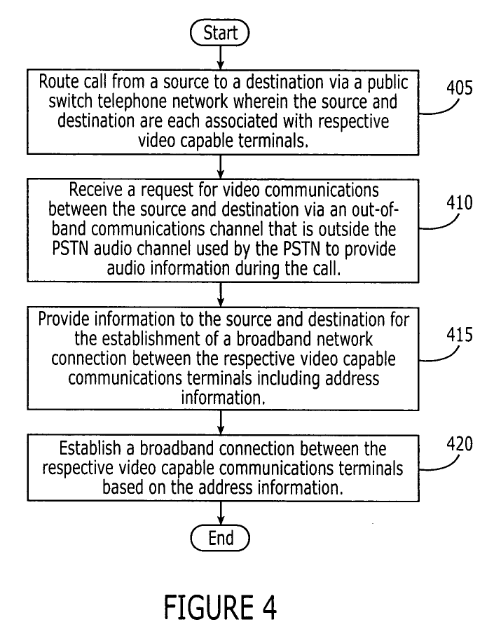

FIG. 4 is a flowchart that illustrates operation of embodiments of terminals and services according to the invention. In particular, a call is routed from a source to a destination via a public switched telephone network wherein the source and destination are each associated with respective video capable terminals (block 405). It will be understood that the call can be routed from the source to the destination by dialing a telephone number at the source that is associated with the destination. It will further be understood that the source and destination each include at least one device that has video capability for the purposes of videoconferencing therebetween.

A request for video communications between the source and destination is received via an out-of-band communications channel that is outside the PSTN audio channel used by the PSTN to provide audio information during the call (block 410). It will be understood that the request for video communication can be received at both the source and destination or, alternatively, at a service that provides for video communication between devices associated with the source and destination. In some embodiments according to the invention, the request is provided via an Advanced Intelligent Network as described above.

Information is provided to the source and destination for the establishment of a broadband network connection between the respective video capable communications terminals (block 415). It will be understood that the information can be provided to each of the devices associated with the source and destination, or alternatively, to the application server that establishes the broadband connection therebetween. It will further be understood that the information can include address information that can be used to establish the broadband connection between the devices associated with the source and destination. A broadband connection is established between the respective video capable communications terminals based on the address information (block 420).

Accordingly to some embodiments of the invention can provide video capable communications terminals that include a public switched telephone network (PSTN) interface circuit that is configured to interface the video capable communications terminal to a PSTN for a call therefrom to a destination. An out-of-band circuit also included in the video capable communications terminal is configured to provide information related to the video capability of a device that is associated with the call via the PSTN. The video capable communications terminal also can include a broadband network interface circuit that is configured to interface the terminal to a broadband network for video communication with the device over the broadband network.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above and what is equivalent thereto.

What is claimed:

1. A video capable communications terminal comprising:
a public switched telephone network (PSTN) interface circuit configured to interface the video capable communications terminal to a PSTN for a call from a source to a destination;
an out-of-band circuit configured to provide information related to video capability of a device included in the call via the PSTN; and
a broadband network interface circuit configured to interface the video capable communications terminal to a broadband network for video communications with the device over the broadband network.

2. A video capable communications terminal according to claim 1 wherein the out-of-band circuit is further configured to provide the information to a device associated with the source.

3. A video capable communications terminal according to claim 1 wherein the out-of-band circuit is further configured to provide the information to a device associated with the destination.

4. A video capable communications terminal according to claim 1 wherein the out-of-band circuit is further configured to provide the information related to video capability via a communications channel outside a PSTN audio channel used by the PSTN to provide audio information during the call.

5. A video capable communications terminal according to claim 4 wherein the communications channel is provided via an Advanced Intelligent Network (AIN).

6. A video capable communications terminal according to claim 4 wherein the communications channel is provided via a network that is separate from the PSTN.

7. A video capable communications terminal according to claim 1 wherein the PSTN interface circuit is further configured to provide audio information to/from the video capable communications terminal associated with the video communications over the broadband network.

8. A video capable communications terminal according to claim 1 wherein the broadband network interface circuit is further configured to provide audio information to/from the video capable communications terminal associated with the video communications over the broadband network.

9. A video capable communications terminal according to claim 1 further comprising:
a processor circuit configured to enable the broadband network interface circuit to provide video communications over the broadband network based on the information related to video capability associated with the destination.

10. A video capable communications terminal according to claim 9 wherein the processor circuit is further configured to enable the broadband network interface circuit based on an input to use the video capability associated with the destination.

11. A video capable communications terminal according to claim 10 further comprising:
a keypad configured to provide input to the processor circuit based on a user selection to use the video capability associated with the destination.

12. A video capable communications terminal according to claim 1 wherein the video capable communications terminal comprises a wireless video capable communications terminal.

13. A video capable communications terminal according to claim 1 wherein the broadband network interface circuit comprises a DSL network interface circuit, a cable network interface circuit, an ISDN interface circuit, and/or a wideband wireless interface circuit.

14. A video capable communications terminal according to claim 1 wherein the broadband network interface circuit is further configured to receive address information for the device having the video capability associated with the destination.

15. A video capable communications terminal according to claim 14 wherein the address information comprises an Internet Protocol address for the device associated with the destination.

16. A method of providing for video communications between communications terminals comprising:
receiving a request for video communications between a source and a destination based on a call via a public switched telephone network (PSTN); and
providing information to the source and the destination for establishment of a broadband network connection between devices associated with the source and destination for video communications therebetween.

17. A method according to claim 16 wherein receiving a request for video communications comprises receiving the request via an out-of-band communications channel outside a PSTN audio channel used by the PSTN to provide audio information during the call.

18. A method according to claim 16 wherein receiving a request for video communications comprises receiving the request via an Advanced Intelligent Network (AIN).

19. A method according to claim 16 wherein receiving a request-for video communications comprises receiving the request via a network that is separate from the PSTN.

20. A method according to claim 16 wherein providing information to the source and the destination for establishment of a broadband network connection comprises providing address information associated with at least one device associated with the source or the destination having video capability for use in conjunction with the call.

21. A method according to claim 16 wherein providing information to the source and the destination for establishment of a broadband network connection comprises providing address information to more than one device associated with the source or the destination each having video capability for multi-cast use in conjunction with the call.

22. A method according to claim 16 wherein providing information to the source and the destination for establishment of a broadband network connection comprises providing address information for separate video capture and video display devices associated with the source or destination for use in conjunction with the call.

23. A method according to claim 16 wherein providing information to the source and the destination for establishment of a broadband network connection comprises providing address information associated with at least one device associated with the source or the destination having video capability for use in conjunction with the call; and
wherein the method further comprises:
providing audio information between the devices associated with the source and destination for use in conjunction with the call.

24. A method according to claim 16 wherein one of the devices comprises a wireless video capable communications terminal.

25. A method according to claim 16 wherein the broadband network connection comprises a network connection via a DSL network, a cable network, an ISDN, and/or a wideband wireless network.

26. A method according to claim 16 further comprising:
establishing the broadband connection between the respective video capable communications terminals based on respective address information associated therewith.

27. A method of providing for video communications between communications terminals comprising:
routing a call from a source to a destination via a public switched telephone network (PSTN), the source and destination each being associated with respective video capable communications terminals;
receiving a request for video communications between the source and a destination via an out-of-band communications channel outside a PSTN audio channel used by the PSTN to provide audio information during the call;
providing information to the source and the destination for establishment of a broadband network connection between respective video capable communications terminals for video communications therebetween; and
establishing the broadband connection between the respective video capable communications terminals based on respective address information associated therewith.

28. A system for providing video communications between communications terminals comprising:
means for receiving a request for video communications between a source and a destination based on a call via a public switched telephone network (PSTN); and
means for providing information to the source and the destination for establishment of a broadband network connection between devices associated with the source and destination for video communications therebetween.

29. A computer program product for communicating between service nodes in a service grid comprising:
a computer readable medium having computer readable program code embodied therein, the computer readable program product comprising:
computer readable program code configured to receive a request for video communications between a source and a destination based on a call via a public switched telephone network (PSTN); and
computer readable program code configured to provide information to the source and the destination for establishment of a broadband network connection between devices associated with the source and destination for video communications therebetween.
